(19) United States
(12) Patent Application Publication
(10) Pub. No.: US 2026/0178314 A1
(43) Pub. Date: Jun. 25, 2026

(54) PROGRAM UPDATE METHOD IN A MICROCONTROLLER

(71) Applicant: STMicroelectronics International N.V., Geneva (CH)

(72) Inventor: Aurelien BUHRIG, Saint-Martin-d'Uriage (FR)

(73) Assignee: STMicroelectronics International N.V., Geneva (CH)

(21) Appl. No.: 19/423,087

(22) Filed: Dec. 17, 2025

(30) Foreign Application Priority Data
Dec. 20, 2024 (FR) FR2415029

(51) Int. Cl. G06F 8/65

(52) U.S. Cl. CPC G06F 8/65

(57) ABSTRACT

One or more programs of a microcontroller are updated using an update method including individually updating different images of the one or more programs. The updating of each image includes: selecting of a program to be executed, from among several programs, on booting of the microcontroller; selecting one or more memory slots of the one or more programs into which to load an image used for the update; and updating version and image dependency data of the one or more programs contained in an update program.

### PRIORITY CLAIM

This application claims the priority benefit of French Application for Patent No. FR2415029, filed on Dec. 20, 2024, the content of which is hereby incorporated by reference in its entirety to the maximum extent allowable by law.

### TECHNICAL FIELD

The present disclosure generally concerns methods of updating a program in a microcontroller and microcontrollers implementing such methods.

### BACKGROUND

Certain microcontrollers may implement an update of one or more of their programs. Current methods of updating programs in microcontrollers however require a significant use of memory space.

There exists a need to provide a method of updating a program of a microcontroller limiting the required memory space.

There is a need in the art to overcome all or part of the disadvantages of known update methods.

### SUMMARY

An embodiment provides a method of updating one or more programs of a microcontroller, the method comprising the individual update of different images of said one or more programs, wherein the update of each image of the different images comprises: selecting a program to be executed, from among a plurality of programs, on booting of the microcontroller; selecting one or more memory slots of said one or more programs into which to load an image used for the updating; and updating version and image dependency data of said one or more programs contained in an update program.

An embodiment provides a microcontroller, comprising one or more programs, and an update program, wherein the microcontroller is configured to implement an individual updating of different images of said one or more programs, wherein updating of each image of the different images comprises: selecting a program to be executed, from among a plurality of programs, on booting of the microcontroller; selecting one or more memory slots of said one or more programs into which to load an image used for the updating; and updating version and image dependency data of said one or more programs contained in an update program.

According to an embodiment, the selection of the program to be executed on booting of the microcontroller is performed from among said one or more programs, wherein one program of said one or more programs is an update loading program and another program of said one or more programs is an application program.

According to an embodiment, the update of each of the images further comprises selecting a method of installing updates to be used by the update program.

According to an embodiment, said one or more selected memory slots comprises a memory slot of one or more images of said one or more programs.

According to an embodiment, updating each of the images further comprises updating configuration data of the update program comprising data associated: with the program to be executed; with said one or more memory slots in which to load, prior to their installation, one or more image updates; with the image version and dependency data; and with the selected update installation method.

According to an embodiment, selecting the program to be executed on rebooting of the microcontroller comprises selecting a respective entry point of one among said one or more programs.

According to an embodiment, the application program and the update loading program have images in common.

According to an embodiment, the application program, the update loading program, and the update program are stored in a non-volatile memory of the microcontroller.

According to an embodiment, a first memory slot of said memory is configured to be accessible only by the update program, and to contain said configuration data of the installation program.

According to an embodiment, a second memory slot of said memory is configured to be accessible for reading and writing by the application program and by the update loading program.

According to an embodiment, the updates of the configuration data of the update program are loaded into said second memory slot and then are installed in the first memory slot by the update program.

According to an embodiment, one program among the update loading program or the application program is configured to: download configuration data of the update program; delete images from said one or more programs; and download updates into said one or more memory slots defined in the configuration data of the update program.

An embodiment provides a radio frequency system comprising an update unit, external to the microcontroller, and the microcontroller such as described above, the update loading program of the microcontroller being configured to download image updates from the update unit.

### BRIEF DESCRIPTION OF THE DRAWINGS

The foregoing features and advantages, as well as others, will be described in detail in the rest of the disclosure of specific embodiments given as an illustration and not limitation with reference to the accompanying drawings, in which:

FIG. 1 very schematically shows in the form of blocks a system;

FIG. 2 very schematically shows in the form of blocks an example of a memory configuration of the microcontroller of FIG. 1;

FIG. 3 very schematically shows in the form of blocks an example of a memory configuration of the microcontroller of FIG. 1;

FIG. 4 very schematically shows in the form of blocks an example of a memory configuration of the microcontroller of FIG. 1;

FIG. 5 illustrates a program update method; and

FIG. 6 illustrates a program update method.

### DETAILED DESCRIPTION

Like features have been designated by like references in the various figures. In particular, the structural and/or functional features that are common among the various embodiments may have the same references and may dispose identical structural, dimensional and material properties.

For the sake of clarity, only those steps and elements that are useful for understanding the described embodiments have been shown and are described in detail.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following description, where reference is made to absolute position qualifiers, such as the terms “front”, “back”, “top”, “bottom”, “left”, “right”, etc., or relative position qualifiers, such as the terms “top”, “bottom”, “upper”, “lower”, etc., or orientation qualifiers, such as “horizontal”, “vertical”, etc., reference is made unless otherwise specified to the orientation of the drawings.

Unless specified otherwise, the expressions “about”, “approximately”, “substantially”, and “in the order of” signify plus or minus 10% or 10°, preferably of plus or minus 5% or 5°.

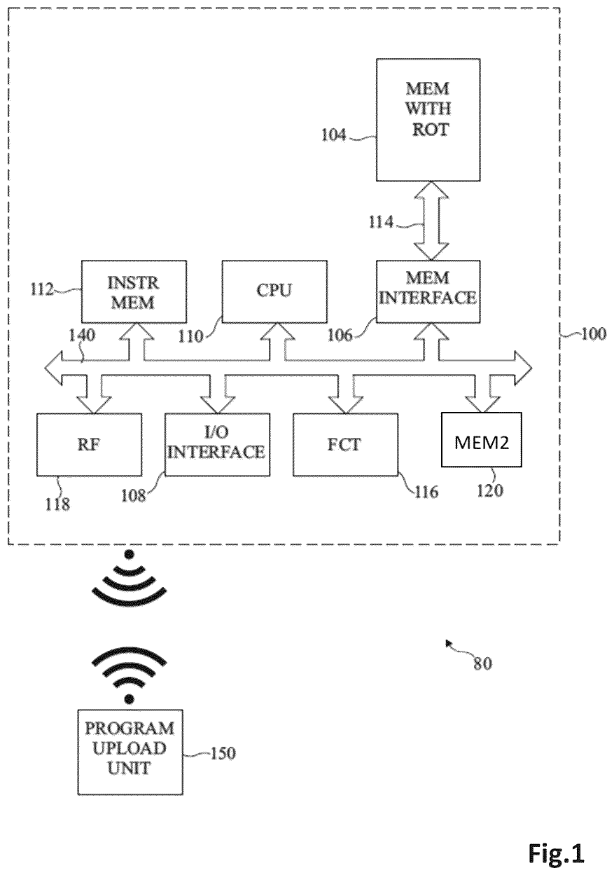

FIG. 1 very schematically shows in the form of blocks a system 80.

System 80 comprises, for example, a microcontroller 100 capable of communicating in wireless or wired fashion with an update unit 150 (PROGRAM UPLOAD UNIT).

Microcontroller 100 comprises a non-volatile memory 104 (MEM WITH ROT), for example of FLASH memory type or of phase-change memory type, capable of communicating, via a communication bus 114, with a non-volatile memory interface 106 (MEM INTERFACE) configured to write or read data to and from non-volatile memory 104. In an example, system programs and/or applications, such as boot programs, are implemented in memory 104. Memory 104 comprises, for example, a program configured to manage other programs stored in memory 104. These other programs are, for example, applications developed by users of the microcontroller, or wireless protocol stacks which enable, when they are executed, to implement a data communication with update unit 150. Memory 104 may also comprise a program enabling to implement an update of the data, programs, or applications present, for example, in memory 104.

Microcontroller 100 further comprises, for example, a processing unit 110 (CPU) comprising one or more processors under control of instructions stored, for example, in a system memory 112 (INSTR MEM) or in memory 104. Instruction memory 112 is, for example, a volatile random access memory (RAM). Processing unit 110 and memory 112 communicate, for example, via a system (data, address and instruction) bus 140. Memory 104 is coupled to system bus 140 via non-volatile memory interface 106 and via bus 114.

Microcontroller 100 further comprises an input/output interface 108 (I/O INTERFACE) coupled to system bus 140 to communicate with the outside.

Microcontroller 100 further comprises, for example, another memory 120 (MEM2) of non-volatile type or of RAM type. This memory 120 is coupled to system bus 140 directly or via a (non-illustrated) memory interface having a role, for example, similar to that of interface 106.

Microcontroller 100 may integrate other circuits implementing other functions (for example, one or more volatile and/or non-volatile memories, other processing units), symbolized by a block 116 (FCT) in FIG. 1.

Microcontroller 100 may further integrate other circuits, such as wireless communication circuits 118 (RF) having, for example, impedance matching circuits and which are configured to be coupled to one or more antennas.

It may be necessary to update the program(s) present in memory 104.

Further, certain local regulations, such as the Radio Equipment Directive (RED) in Europe, or certain certification schemes like PSA© or SESIP, require having secure update capabilities.

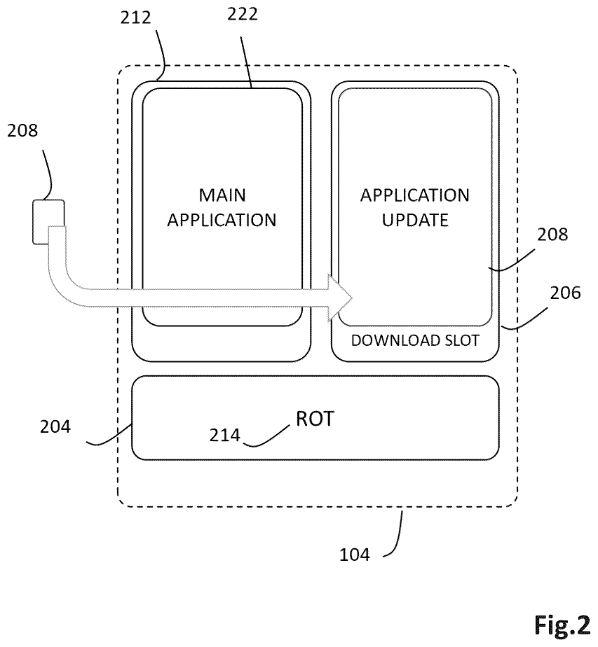

FIG. 2 very schematically shows in the form of blocks an example of a memory of a microcontroller. More particularly, the shown example illustrates an example of the memory 104 of microcontroller 100.

The example of FIG. 2 enables to implement, for example, an over-the-air (OTA) update. The shown implementation, for example, enables to implement an update of a so-called main program 222 (MAIN APPLICATION) stored in a memory slot 212 of memory 104. In an example, program 222 is formed of one or more images, which are, for example, files, for example, binary, formed by instruction and/or data sequences.

Memory 104 may be divided into a plurality of memory slots which can be referred to as primary or secondary. Primary slots, such as slot 212, are the slots containing images with code or data directly accessible by main program 222. Secondary slots, such as a slot 206 (DOWNLOAD SLOT), are slots enabling to store updates, in other words, other, downloaded versions of program 222, which may, for example, be installed in primary slot 212.

Memory 104 comprises, for example, another memory slot 204, within which is stored an update program 214 (Root of Trust (ROT)). The ROT program comprises, for example, a secure boot program verifying the authenticity of program 222 before its execution. If program 222 is made up of a plurality of images, the consistency of program 222 is also verified by means of dependency information. The ROT program, enabling a secure booting and the installation of updates, may for example be developed by means of the MCUBoot© library.

The ROT program is executed at the booting of microcontroller 100, and is also configured to detect possible updates in the secondary memory slots, and if necessary to install the updates. The installing of an image from a memory slot, called “secondary”, 206 to a memory slot, called “primary” 212, comprises authenticating an update image 208 (APPLICATION UPDATE), verifying that the downloaded version is not an old version (anti-rollback), and optionally decrypting the update image. The decrypted image is then copied in place of image 222 to be able to be used. This update image 208 of program 222 is downloaded, for example from update unit 150, and loaded into memory slot 206.

The example of FIG. 2 implies for the total memory space required for the update of program 222 to be approximately double the memory space occupied by program 222, which implies significant costs or a limitation of the memory available for program 222 and thus a limitation of its functionalities.

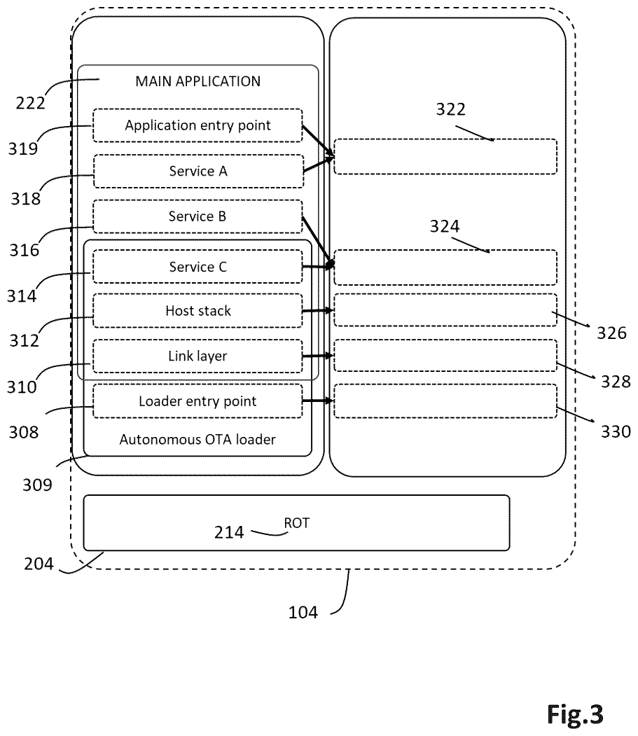

FIG. 3 very schematically shows in the form of blocks an example of a memory of a microcontroller. More particularly, the shown example illustrates an example of the memory 104 of microcontroller 100.

The example of FIG. 3 is similar to that of FIG. 2, except that the program 222 to be updated is made up of a plurality of images, otherwise known as services, 318 (Service A), 316 (Service B), 314 (Service C), 312 (Host stack), 310 (Link layer), stored in respective memory slots. Program 222 also comprises an application entry point 319, which represents, for example, the instruction, or the series of instructions, implemented first on execution of program 222. In an example, image 319 corresponds to the core of the application, image 316 corresponds to functions linked, for example, to identification in relation to a remote portal (cloud), image 314 corresponds to a cryptography library, and images 312 and 310 correspond, for example, to the implementation of a wireless communication protocol.

In the example shown in FIG. 3, memory 104 further comprises another program 309 (Autonomous OTA loader), which is an update loading program. Program 309 comprises, for example, images 310, 312 and 314 as well as a loader entry point 308. Entry point 308 represents, for example, the first instruction or a series of instructions, implemented first on execution of program or application 308. Program 309 has the function, for example, of fetching, in a remote location, an update and of downloading it. In the example of FIG. 3, the references of the versions of the different images of program 309, as well as their dependencies, are stored in each image. The images may also comprise a signature associated with an encryption.

The program 309 shown in FIG. 3 runs, for example, with no dependency to images 316, 318 and 319, which are specific to program 222.

In the example shown in FIG. 3, images 314, 312 and 310 are common to programs 222 and 309. This enables to limit the memory space used.

In a non-illustrated example, other programs, for example related to manufacturing, calibration, or diagnosis, may be incorporated into memory 104.

By using current update mechanisms, such as those present in the MCUboot© library, the secondary memory slots need to be statically defined on compiling of ROT update program 214. Thus, in the example of FIG. 3, additional memory slots 322, 324, 326, 328, and 330 need to be reserved to handle the worst case in which it is necessary to download updates for all images 308, 310, 312, and 314 of application 309 (OTA loader) before installing them and rebooting application 309. This is costly in terms of consumed memory space. In addition, the MCUBoot© library supports only one fixed entry point, 308 or 319, to be defined for the booting of ROT update program 214. Another disadvantage of this library is that it is not possible to reconfigure different write modes according to the images to be updated. For example, it is not possible for certain images to be installed, on update by ROT update program 214, with an install-in-place method, and for other images to be installed with another method, such as that based on swap/backup or also that based on overwriting.

Another limitation of current protocols results from the fact that the dependency information for each image is stored within this same image. In other words, if a given first image depends on another image which has been updated, then the dependency information of the first image also needs to be updated, and thus the first image also needs to be updated. This limits the effectiveness of the update strategy.

In order to overcome the disadvantages of the examples of FIGS. 2 and 3, the embodiments provide a method for updating one or more programs of a microcontroller (such as for example application program 222 or program 309), the method comprising the individual updating of different images of said one or more programs, the updating of each of these images comprising: the selection of a program to be executed, from among a plurality of programs, on booting of the microcontroller; the selection of one or more memory slots of said one or more programs into which to load an image used for the update; and the update of version and image dependency data of said one or more programs, contained in the update program.

According to an aspect, each image update further comprises the selection of a method of installation of the update to be used by the ROT update program.

In other words, the provided method implements the updating, separately or independently, of one or more images making up one or more programs, for example from among programs 222, 309. The images to be updated are, for example, independent of one another.

The selection steps, and the version and dependency data update step, being implemented for each updated image, this enables to configure them differently for each image. A dynamic update configuration is thus implemented, which enables to establish a flexible update strategy.

This enables a dynamic configuration of the ROT update program to implement the selection steps and the version and dependency data update step, in a differentiated way for each image to be updated.

This also enables to dispense with additional memory slots dedicated to the updated images, by reusing primary slots of updated images.

In the following examples, the memory slots selected, in other words, configured, for an image used for updating to be loaded therein, are referred to as secondary slots. The memory slots in which images are initially stored, before their update, are referred to as primary slots.

The methods described in the embodiments also enable the independent update of one or more images of a program comprising these images, within this same program with no additional memory slot.

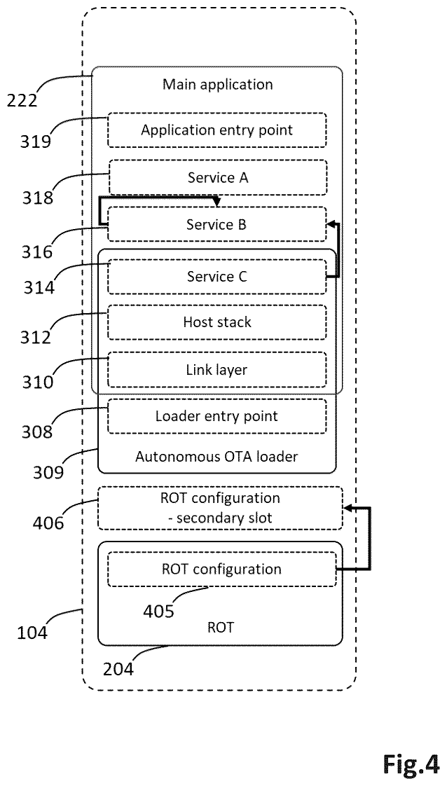

FIG. 4 very schematically shows in the form of blocks an example of the memory 104 of the microcontroller 100 of FIG. 1.

In the shown example, memory 104 comprises programs 222 and 309 similar to those of FIG. 3.

In this example, memory slot 204, comprising the ROT program, comprises a memory slot 405 (ROT configuration) which comprises the configuration of the ROT program.

In an example, primary memory slot 405 contains the current configuration of ROT program 204 and is configured to be accessible only by this ROT update program. This slot 405 contains, for example, the address of the active program to be verified and executed at the booting, from among programs 222 and 309 for example. The cryptographic hardware associated with the ROT update program enables to decrypt and authenticate the update images, as well as the information of each image of the system. This information comprises, for example: the data enabling to verify the integrity and/or the authenticity of the image, such as for example a hash considered as the result of a hash tag function, or a signature; the image dependency data to guarantee the consistency of the versions used; the addresses of the primary and secondary (or additional) slots, where the image and its update are respectively located; and the installation method.

Optionally, memory 104 comprises a secondary memory slot 406 (ROT configuration), configured to be accessible for reading and writing by program 222 and/or by update loading program 309. A new configuration version for the ROT program is, for example, loaded into memory slot 406, together with program 222, and/or with update loading program 309, and this, prior to its installation by the ROT program within memory slot 405.

Thanks to the example of FIG. 4, in an example, it is possible to define a dynamic and sequential update strategy enabling to consecutively update images 314 and 316, by reusing slot 316 alone to store the update images (arrows in FIG. 4). Images 314 and 316 may be updated with a different installation method, without using dedicated secondary memory slots, as is the case with memory slot 206, which can thus be removed or used to increase the size of program 222.

The example of FIG. 4 further enables to dynamically define the configuration of the ROT program to modify, for example at different stages of the updates of images 314 or 316, the selection of the program to be executed on rebooting of microcontroller 100, and/or the selection of a memory slot in which to load one or more updates, and/or the method of update installation by the ROT program.

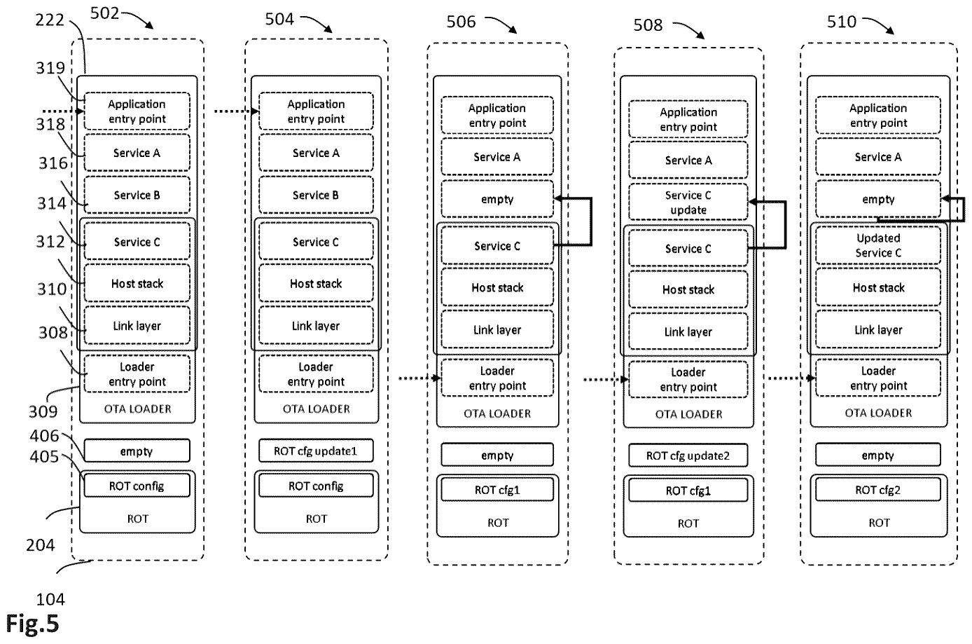

FIG. 5 illustrates a program update method.

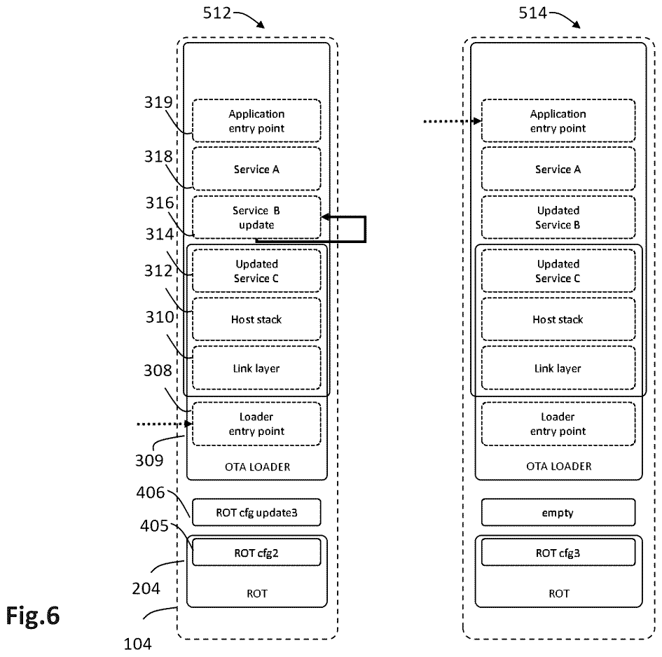

FIG. 6 illustrates a program update method.

FIGS. 5 and 6 show, together, a possible example of steps of a same method enabling to sequentially update the image 314 contained in programs 222 and 309, and the image 316 only contained in program 222.

At a step 502, memory 104 is similar to that of the example of FIG. 4, with memory slot 406 initially empty. The RoT update program is configured to verify the integrity, the consistency, and the authenticity of program 222 and verifies all the images 310, 312, 314, 316, 318, and 319 making up this program 222. Once this has been verified, program 222 is booted by executing image 319 (shown with an arrow in dotted lines).

At a step 504, subsequent to step 502, a first version (ROT cfg update1) of configuration data of the ROT program is loaded into memory slot 406, for example with program 222. The first version of the configuration data of the ROT program comprises, for example, a first version of the image dependency data 308, 310, 312, 314, and/or a first selection of the program 309 to be executed when microcontroller 100 is rebooted, and/or a first selection of a secondary memory slot in which to load one or more updates, and/or a first selection of the method of installation of the loaded updates by the ROT program. In this first version of configuration data of the ROT program, the update loading program 309 (OTA LOADER) is selected, in other words configured, to be executed on rebooting of the microcontroller. Image memory slot 316, which is not used by update loading program 309, is selected to load an update image 314 therein (Service C update).

At steps 506 and 508, subsequent to step 504, microcontroller 100 is rebooted and the ROT update program verifies the authenticity and the version of the image, optionally decrypts image 406 (ROT cfg update1), and then installs (ROT cfg1) the first configuration version in slot 405. The ROT update program verifies the integrity, the authenticity, and the version of program 309 and starts it. Then, update loading program 309 deletes image 316. It also downloads an image used for the update of image 314 as well as a second version (ROT cfg update2) of the configuration data of the ROT program to load them, respectively, into the memory slots of the original image 316, and into memory slot 406.

At a step 510, subsequent to step 508, the microcontroller is rebooted and the ROT update program installs (ROT cfg2) the update of image 314 (Updated Service C), from the location of the initial image 316, into the memory slot where the image 314 to be updated is stored, and this, for example by overwriting, or in place of, the image 314 to be updated. The ROT update program also installs (ROT cfg2) the second version of ROT program configuration data in the primary memory slot 405 by overwriting, or in place of, the first configuration version of the ROT program. The installation of the new configuration (ROT cfg2) enables, in particular, to define the secondary slot of image 316 at the same location as primary slot 316, as defined by the install-in-place method. It also enables to update the version and dependency information of program 309 to take into account the installation of the new Updated Service C image contained in program 309.

At a step 512, subsequent to step 510, update loading program 309 downloads an image (Service B update) used for the updating of image 316 as well as a third version (ROT cfg update3) of the configuration data of the ROT program, and loads them, respectively, into secondary memory slots 316 and 406.

At a step 514, subsequent to step 512, the microcontroller is rebooted and the ROT update program installs the update of image 316 (Updated Service B) in the primary memory slot of image 316 based on the image used for the update of the previously-downloaded image 316, then installs (ROT cfg3) the third version of the configuration data of the ROT program in memory slot 405. At step 514, the third version of the configuration data of the ROT program comprises the selection of program 222 as well as all the image dependency information used by program 222, so that program 222 is verified and executed at the next rebooting of the microcontroller.

According to an example of the method of FIGS. 5 and 6:
In a first step, a configuration of the ROT update installation program is carried out so that the first memory slot 405 comprises a first version ROT cfg1 of configuration data of the ROT installation program, so that the update loading program 309 is selected to be executed on rebooting of microcontroller 100, and so that a memory slot of a first image 316 of application program 222 is selected to load therein an image Service C update used to update a second image 314 of application program 222.

In a second step, the microcontroller is rebooted, and then update loading program 309 downloads the image Service C update used for the updating of the second image 314 as well as a second version of the configuration data of the ROT installation program, respectively, into the memory slot of the first image 316 instead of the first image, and into the second memory slot 406, the second version ROT cfg2 of the configuration data of the ROT installation program defining: the memory slot where the first image 316 has been stored as being the location where the image Service C update used for the updating of the second image 314 is located, the location of the second image 314 as being the location where to install the update Updated Service C of the second image 314, and the method of installation with a copy.

In a third step, the microcontroller is rebooted and the ROT installation program installs: the image of update Updated Service C, by using the image Service C update used for the update of the second image 314, in place of the second image 314, and the second version ROT cfg2 of the configuration data of the ROT installation program in the first memory slot 405.

In a fourth step, update loading program 309 downloads: an image Service B update used for the update of the first image 316, and a third version ROT cfg3 of the configuration data of the ROT update program, respectively, into the memory slot where the first image 316 has been stored, and into the second memory slot 406, the third version ROT cfg3 of the configuration data comprises the selection of the application program 222 as well as of the information of dependency of the images contained in the application program 222.

In a fifth step, microcontroller 100 is rebooted, after which the ROT update program: installs the update of the first image Updated Service B from and into the memory slot of the first image 316 by using the image Service B update used for the update of the first image 316; installs the third version ROT cfg3 of the configuration data of the ROT installation program in the first memory slot 405; verifies the authenticity, the integrity, and the consistency of the versions of the images contained in application program 222; and selects the program 222 to be executed on rebooting of microcontroller 100.

The update method of FIGS. 5 and 6 enables to update a plurality of images of a program without additional memory space, while enabling to respect security.

The described microcontroller may be used in personal electronic equipment, for example so as to update the applications to apply functional or security corrections, in 5G connection devices or more generally in connected devices. The device is, for example, a smartphone or is part of an Internet-of-Things network. The microcontroller is, for example, integrated in a radio frequency communication product connected in 5G, NFC, WIFI, UWB (ultra wide band), of NFC (Near Field Communication) type, of LORA, SIGFOX, or Bluetooth® type. The product incorporating the microcontroller potentially includes filters or protections against magnetic fields or electric discharges. The described microcontroller can also be used in satellites.

Various embodiments and variants have been described. Those skilled in the art will understand that certain features of these various embodiments and variants may be combined, and other variants will occur to those skilled in the art. In particular, although the examples in FIGS. 5 and 6 show the updating of two images 316 and 314, those skilled in the art can use the teachings of the description to implement the updating of a single image or of more than two images of a same program with different update strategies.

Finally, the practical implementation of the described embodiments and variants is within the abilities of those skilled in the art based on the functional indications given hereabove. In particular, with regard to the protocol of download by program 309 which, even though it has been described in the text as being configured for wireless updating, can be adapted for wired updating. In this case, the communication with unit 150 will be wired.

1. A method of updating one or more programs of a microcontroller comprises individually updating different images of said one or more programs, wherein updating each image of the different image comprises:
selecting, from among a plurality of programs, a program to be executed on booting of the microcontroller;
selecting one or more memory slots of said one or more programs into which to load an image used for updating; and
updating version and image dependency data of said one or more programs contained in an update program.

2. The method according to claim 1, wherein selecting the program to be executed on booting of the microcontroller comprises selecting from among said one or more programs, wherein one of said one or more programs is an update loading program and another of said one or more programs is an application program.

3. The method according to claim 2, wherein the application program and the update loading program have images in common.

4. The method according to claim 2, wherein the application program, the update loading program, and the update program are stored in a non-volatile memory of the microcontroller.

5. The method according to claim 4, wherein a first memory slot of said memory is configured to be accessible only by the update program, and to contain configuration data of the installation program.

6. The method according to claim 5, wherein a second memory slot of said memory is configured to be accessible for reading and writing by the application program and by the update loading program.

7. The method according to claim 6, wherein updates of the configuration data of the update program are loaded into said second memory slot and are then installed in the first memory slot by the update program.

8. The method according to claim 1, wherein updating each image further comprises selecting an update installation method to be used by the update program.

9. The method according to claim 1, wherein said one or more selected memory slots comprises a memory slot of one or more images of said one or more programs.

10. The method according to claim 9, wherein updating each image further comprises updating configuration data of the update program comprising data associated with: the program to be executed; said one or more memory slots in which to load, prior to their installation, one or more image updates; the image version and dependency data; and the selected update installation method.

11. The method according to claim 10, wherein a program from among the update loading program or the application program is configured to: download configuration data of the update program; delete images from said one or more programs; and download updates into said one or more memory slots defined in the configuration data of the update program.

12. The method according to claim 1, wherein selecting the program to be executed on rebooting of the microcontroller comprises selecting a respective entry point of one among said one or more programs.

13. The method according to claim 1, wherein updating each of these images comprises:
performing a first update of a configuration of an update program, the first update comprising:
updating a version and image dependency data of said one or more programs;
selecting, from among one of said one or more programs, an update loading program to be executed on next booting of the microcontroller; and
selecting one or more first memory slots of said one or more programs that are not used by said update loading program;
then, after a boot of said microcontroller:
verifying said update loading program by the update program using the version and image dependency data of the first update of the configuration of the update program;
executing said update loading program comprising loading data related to the updating of the individual image into said one or more first memory slots; and
loading a second update of the configuration of the update program comprising selecting the update loading program to be executed on next booting, and selecting one or more second memory slots of the update loading program corresponding to the individual image to update.

14. The method according to claim 13, wherein updating each of these images further comprises, after a boot of said microcontroller:
verifying said update loading program by the update program using the version and image dependency data of the second update of the configuration of the update program; and
executing said update loading program comprising loading of said data related to the updating of the individual image into the selected one or more second memory slots, wherein the data loaded into said one or more second memory slots corresponds to the individual image update.

15. A microcontroller, comprising:
one or more programs and an update program;
wherein the microcontroller is configured to implement individual updating of different images of said one or more programs;
wherein updating each of these images comprises:
selecting, from among a plurality of programs, a program to be executed on booting of the microcontroller;
selecting one or more memory slots of said one or more programs into which to load an image used for the updating; and
updating version and image dependency data of said one or more programs contained in an update program.

16. The microcontroller according to claim 15, wherein the plurality of programs include an update loading program and an application program; wherein the application program and the update loading program have images in common; and wherein the application program, the update loading program, and the update program are stored in a non-volatile memory of the microcontroller.

17. The microcontroller according to claim 16, wherein: a first memory slot of said memory is configured to be accessible only by the update program, and to contain configuration data of the installation program; and a second memory slot of said memory is configured to be accessible for reading and writing by the application program and by the update loading program.

18. The microcontroller according to claim 17, wherein updates of the configuration data of the update program are loaded into said second memory slot and the update program is configured to install the updates in the first memory slot.

19. The microcontroller according to claim 15, wherein said one or more selected memory slots comprises a memory slot of one or more images of said one or more programs; and wherein updating each image further comprises updating configuration data of the update program comprising data associated with: the program to be executed; said one or more memory slots in which to load, prior to their installation, one or more image updates; the image version and dependency data; and the selected update installation method.

20. The microcontroller according to claim 19, wherein a program from among the update loading program or the application program is configured to: download configuration data of the update program; delete images from said one or more programs; and download updates into said one or more memory slots defined in the configuration data of the update program.

21. The microcontroller according to claim 15, wherein selecting the program to be executed on rebooting of the microcontroller comprises selecting a respective entry point of one among said one or more programs.

22. A radio frequency system, comprising:
the microcontroller according to claim 15; and
an update unit external to the microcontroller;
wherein the update loading program of the microcontroller is configured to load image updates from the update unit.
